(19) United States
(12) Patent Application Publication
(10) Pub. No.: US 2010/0090916 A1
(43) Pub. Date: Apr. 15, 2010

(54) Flexible vehicular antenna mount

(75) Inventor: Daniel J. Degutis, Odenton, MD (US)

Correspondence Address: Law Offices of Kenneth W. Float, #2F, 2095 Hwy. 211, Braselton, GA, 30517, US

(73) Assignee: Antenna Research Associates, Inc.

(21) Appl. No.: 12/287,795

(22) Filed: Oct. 14, 2008

(51) Int. Cl. H01Q 1/32

(52) U.S. Cl. 343/713

(57) ABSTRACT

Disclosed is a flexible vehicular antenna mount having top and bottom plates and a plurality of laterally-offset springs coupled between the top and bottom plates. Flexible bellows is secured to the top and bottom plates that encloses the laterally-offset springs. Molded rubber elements are disposed within each of the laterally-offset springs to provide dampening. The plurality of laterally-offset springs may also be offset from each other in an orthogonal direction relative to a line between them.

### BACKGROUND

The present invention relates generally to antenna mounts, and more particularly, to a flexible antenna mount for attaching an antenna to a vehicle.

Military vehicles are often required to have relatively long “stick” or “whip” type antennas mounted or attached to them. Typical “stick” type antennas have a length to diameter ratio of between approximately 10:1 to 100:1. These antennas are hard mounted to a vehicle and typically include some type of spring mechanism to allow flexing of the antenna. The antennas are designed to handle multiple impacts of up to 25 mph while continuing to operate.

The traditional method for meeting this specification is to provide a large spring at the antenna base that bends and extends to absorb impacts. By varying the spring parameters (such as spring constant, wire size, etc.), different sized antenna systems can be mechanically “tuned” to provide adequate flexure while at the same time minimizing shock to internal components of the antenna. This single spring design is common in the antenna industry. However, as antennas increase in length and mass, the conventional directionally uniform solution is inadequate.

It would be desirable to have an improved flexible vehicular antenna mount that overcomes limitations of conventional single-spring designs.

### BRIEF DESCRIPTION OF THE DRAWINGS

The various features and advantages of the present invention may be more readily understood with reference to the following detailed description taken in conjunction with the accompanying drawings, wherein like reference numerals designate like structural elements, and in which:

FIG. 1-1c show perspective, top, side and end views, respectively, of an exemplary flexible vehicle mounting structure for an antenna.

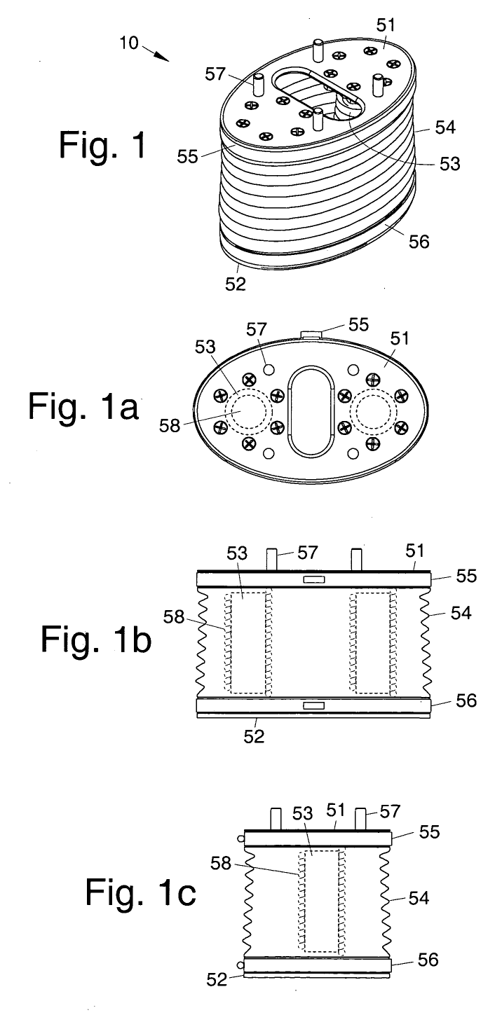

### DETAILED DESCRIPTION

Referring to the drawing figures, disclosed is an exemplary spring-loaded mounting structure 50 for connecting an antenna 10 to a vehicle. The spring-loaded mounting structure 50 allows flexing of the antenna 10 if the vehicle on which it is mounted is moving, or if the antenna 10 is impacts something or is subject to wind or other external forces. The spring-loaded mounting structure 50 minimizes shock imparted to internal components of the antenna 10.

Conventional spring-loaded mounting structures utilize only one spring, which limits flexural stability. To overcome the limitations of such conventional mounts, the spring-loaded mounting structure 50 comprises a plurality of (preferably two) internal springs 53 that are coupled to top and bottom plates 51, 52. The two internal springs 53 are disposed in a side by side arrangement. The spring-loaded mounting structure 50 also comprises a flexible bellow 54 that is secured to the top and bottom plates 51, 52 by top and bottom hose clamps 55, 56. A plurality of threaded studs 57 (four, for example) extend from the top plate 51 to allow connection of the antenna 10 (such as by way of a base coupling structure) to the spring-loaded mounting structure 50.

This side by side spring arrangement doubles the flexing force in the forward-backward directions and at the same time creates substantially more resistance in a side to side flexing mode. This also allows use of material sizes (wire diameter) that can be wound to produce production lots of springs 53 of consistent force. This allows the antenna 10 to flex from a forward impact (by far the most common) while resisting side to side motion created from vehicle turns and rough roads. The shock imposed on internal components of the antenna 10 is minimized and the overall stability of the antenna 10 is increased due to the asymmetrical resistance that is created by the use of two or more side-by-side springs 53.

The springs 53 may also be arranged in an offset pattern. The required bending force can be increased or decreased using varying impact angles created by the offset. This allows for fine-tuning of the antenna mounting structure 50 to optimize the tradeoff between stiffness and shock absorption. Force increases by the cosine of the angle of impact. Also, forward impacts to the antenna 10 result in displacements directed away from the vehicle for safety and vehicle protection. These benefits are not possible with single spring designs.

To add a dampening effect to conventional antenna mounting mechanisms, the industry uses a rubber sleeve disposed over the spring that is hose-clamped in place. In contrast, the springs 53 of the spring-loaded mounting structure 50 have internal molded rubber center elements 58. A liquid cured type rubber is preferably used to fabricate the molded rubber center elements 58 that is both effective and does not suffer from problems of current industry designs that use clamps that can move or become loose.

Thus, an improved flexible vehicular antenna mount has been disclosed. It is to be understood that the above-described embodiments are merely illustrative of some of the many specific embodiments that represent applications of the principles discussed above. Clearly, numerous and other arrangements can be readily devised by those skilled in the art without departing from the scope of the invention.

What is claimed is:

1. Apparatus, comprising:
a top plate for connecting to an antenna;
a bottom plate for connecting to a vehicle; and
a plurality of laterally-offset springs coupled between the top and bottom plates.

2. The apparatus recited in claim 1 further comprising flexible bellows secured to the top and bottom plates that encloses the springs.

3. The apparatus recited in claim 1 wherein the flexible bellows is secured to the top and bottom plates using a plurality of hose clamps.

4. The apparatus recited in claim 1 further comprising molded rubber elements disposed within each of the springs.

5. The apparatus recited in claim 1 wherein the plurality of laterally-offset springs are also offset from each other in an orthogonal direction.

6. Apparatus, comprising:
top and bottom plates;
a plurality of laterally-offset springs coupled between the top and bottom plates; and
flexible bellows secured to the top and bottom plates that encloses the springs.

7. The apparatus recited in claim 6 wherein the flexible bellows is secured to the top and bottom plates using a plurality of hose clamps.

8. The apparatus recited in claim 6 further comprising molded rubber elements disposed within each of the springs.

9. The apparatus recited in claim 6 wherein the plurality of laterally-offset springs are also offset from each other in an orthogonal direction.

10. A spring-loaded antenna mounting structure comprising:
a top plate for connecting to an antenna;
a bottom plate for connecting to a vehicle;
a plurality of laterally-offset springs coupled between the top and bottom plates; and
flexible bellows secured to the top and bottom plates that encloses the springs.

11. The structure recited in claim 10 wherein the flexible bellows is secured to the top and bottom plates using a plurality of hose clamps.

12. The structure recited in claim 10 further comprising molded rubber elements disposed within each of the springs.

13. The structure recited in claim 10 wherein the plurality of laterally-offset springs are also offset from each other in an orthogonal direction.
